(19) United States
(12) Patent Application Publication
(10) Pub. No.: US 2023/0302685 A1
(43) Pub. Date: Sep. 28, 2023

(54) METHOD FOR PRODUCING A RUBBER MIXTURE, AND USE OF A DEVICE SUITABLE FOR CARRYING OUT THE METHOD

(71) Applicant: Continental Reifen Deutschland GmbH, Hannover (DE)

(72) Inventors: Christopher Wortmann, Langenhagen (DE); Monir Sharifi, Ronnenber (DE); Andreas Kuellig, Hannover (DE); Tim Rennmann, Hannover (DE)

(73) Assignee: Continental Reifen Deutschland GmbH, Hannover (DE)

(21) Appl. No.: 18/005,609

(22) PCT Filed: Jun. 15, 2021
(86) PCT No.: PCT/EP2021/066027

§ 371 Date: Jan. 15, 2023

(30) Foreign Application Priority Data
Jul. 9, 2020 (EP) 20184888.4

(51) Int. Cl. B29B 7/18; C08K 3/36; C08L 21/00; B29B 7/28; B29B 7/74

(52) U.S. Cl. CPC B29B 7/186; B29B 7/286; B29B 7/7495; C08K 3/36; C08L 21/00

(57) ABSTRACT

A device for producing a rubber mixture and/or non-vulcanized vehicle tire components and/or a vehicle tire, comprising a first mixer comprising a mixing chamber with at least one first mixing rotor and with a first volume ratio, and a second mixer comprising a mixing chamber with at least one second mixing rotor and with a second volume ratio, wherein the ratio of said first volume ratio to said second volume ratio lies in the range from 50:1 to 1:10. Also disclosed is the use of the device and a method for producing non-vulcanized vehicle tire components and/or a vehicle tire.

The invention relates to a method for producing a rubber mixture and to the use of a device suitable for performing the method for producing a rubber mixture.

In the rubber industry, widely varying rubber mixtures must be produced on large scales with compositions that are as precise and homogenously distributed as possible. The mixing of individual rubber mixture constituents together thus always involves a target conflict between the fastest possible production of the rubber mixture and achieving the highest possible quality thereof. For the latter in particular, various parameters play a role during production and have a great influence on the final product, which may for example be a vehicle pneumatic tire. One of the most important parameters here is the dispersion of fillers in the rubber mixture and the homogeneity of distribution of the individual constituents in the rubber mixture.

Because of these different requirements, various devices are known for producing rubber mixtures, such as internal mixers which are described for example in more detail in the following documents.

EP 2736690 B1 discloses a “Method for the production of a starting mixture, during which the following steps are carried out sequentially: A - a rubber matrix, reinforcing fillers and, optionally, other components, with the exception of the crosslinking system, are introduced into a mixer device of the internal mixer (100) type, of the type comprising a mixing tank (116) in which rotors (112, 113) are mounted, which are rotated and equipped with radial projections, which form an air gap (e) formed between them and the tank; B - the aforementioned components are mixed in the tank until a homogeneous mixture is obtained, while ensuring that the temperature of the mixture remains below or equal to 170° C. [...]” (see claim 1).

EP 0618055 B1 describes a method for processing base rubber mixtures containing non-reactive additives into finished rubber mixtures using a ram mixer, wherein a previously produced finished base mixture is supplied to the ram mixer for plasticizing, and after plasticization the batch is immediately supplied to a ramless mixer in order to finally mix the finished mixture by the addition of reactive additives at a lower temperature than in the ram mixer.

A device in ever more common use for producing rubber mixtures is the so-called tandem mixer which is already generally known in the prior art:

DE4309451A1 describes a method for producing rubber mixtures in which, in a first stage, using a ram mixer, a base mixture of rubber and non-reactive additives is produced in batches and the base mixture, without intermediate storage, is finally mixed in a ramless mixer in a second stage with the addition of reactive additives, also in batches and at reduced temperature.

Such tandem mixers have considerably reduced the production time of a batch of a rubber mixture. There is therefore a need in the prior art to achieve a sufficiently high dispersion of the fillers in the rubber mixture and/or a sufficiently high homogeneity of distribution of the individual constituents in the rubber mixture in a tandem mixer, without increasing the production time. This applies in particular to modern rubber mixtures with a high proportion of silica.

The problem addressed by the invention is accordingly that of modifying a process for producing a vehicle tire or the use of a device for producing a rubber mixture in such a way that the above-described disadvantages from the prior art are no longer encountered.

This problem is solved according to the invention by a process for producing a rubber mixture, comprising the steps of:
A) mixing of a rubber mixture in a first mixer, wherein the first mixer has a mixing chamber and at least one mixing rotor in the mixing chamber of the first mixer, wherein
   i. the mixing chamber of the first mixer has a first chamber volume,
   ii. the mixing chamber of the first mixer is delimited by a chamber housing, a first filling opening and a first ejection opening, and
   iii. the at least one mixing rotor of the first mixer has a mixing rotor core and at least two first rotor blades,
B) transfer of the rubber mixture mixed in the first mixer into a second mixer, wherein the second mixer has a mixing chamber and at least one mixing rotor in the mixing chamber of the second mixer, wherein
   i. the mixing chamber of the second mixer is delimited by a chamber housing, a second filling opening and a second ejection opening,
   ii.the mixing chamber of the second mixer has a second chamber volume, wherein the volume ratio of the chamber volume of the mixing chamber of the second mixer to the chamber volume of the mixing chamber of the first mixer lies in the range of 15:1 to 1:1, and
   iii. the at least one mixing rotor of the second mixer has a mixing rotor core and at least two second rotor blades,
C) mixing of the rubber mixture mixed in the first mixer in the second mixer, wherein the blade field speeds acting on the rubber mixture during step C) in the mixing chamber of the second mixer are lower than the blade field speeds acting on the rubber mixture during step A) in the mixing chamber of the first mixer.

Surprisingly, it has been found that by increasing the blade field speeds in the first mixing chamber in comparison with the blade field speeds in the second mixing chamber, a better dispersion of the fillers and/or a greater homogeneity is achieved in the rubber mixture. Without wishing to be bound to a scientific theory, it is assumed that the higher blade field speeds in the first mixing chamber achieve a greater dispersion of the fillers of the rubber mixture which is then better distributed in the second mixing chamber. Thus a greater homogeneity of the constituents of the rubber mixture can be achieved.

The increase in blade field speeds may be achieved
qualitatively, i.e. proportionally to the shear speeds, or
quantitatively, i.e. proportionally to the area at which the shear speeds are formed. The latter is quantified below by means of the formula for blade field speed.

Solely the increase in shear speed, or solely the increase in the area at which the shear speeds are formed, leads to a better dispersion of the fillers and/or a greater homogeneity of the constituents of the rubber mixture in the corresponding mixing chamber, which here is preferably and advantageously the first mixing chamber of a device according to the invention. If there is a simultaneous increase in both the shear speed and the area at which the shear speeds are formed, the dispersion of the fillers and/or the homogeneity of the constituents in the rubber mixture are/is disproportionately increased in the corresponding mixing chamber, which here is advantageously the first mixing chamber of a device according to the invention.

In the context of the present invention, the expressions “mixing chamber of the first mixer” and “first mixing chamber” are used synonymously. In the context of the present invention, the expressions “mixing chamber of the second mixer” and “second mixing chamber” are used synonymously. In the context of the present invention, the expressions “mixing rotors” and “mixer rotors” are used synonymously.

A method is preferred as described above or as described as preferred above, in which each mixing chamber comprises at least two mixing rotors as described above, preferably precisely two mixing rotors as described above.

A method is preferred as described above, or as described as preferred above, in which the ratio of the blade field speeds acting on the rubber mixture during step A) in the mixing chamber of the first mixer to the blade field speeds acting on the rubber mixture during step C) in the mixing chamber of the second mixer lies in the range of 1 000 000:1 to 1.01:1, preferably in the range of 100 000:1 to 5:1, particularly preferably in the range of 10 000:1 to 10:1, quite particularly preferably in the range of 500:1 to 100:1.

One advantage of the above-described aspect of the present invention is that the above-described relatively high blade field speeds in the first mixing chamber in comparison with the blade field speeds in the second mixing chamber further improve said homogeneity and/or said dispersion of the fillers in the rubber mixture.

Preference is given to a method as described above or as described as preferable above, wherein
the blade field speeds acting on the rubber mixture during step A) in the mixing chamber of the first mixer lie in the range of 10 m/s to 300 m/s, preferably in the range of 20 m/s to 200 m/s, particularly preferably in the range of 30 m/s to 150 m/s, quite particularly preferably in the range of 4.0 m/s to 100 m/s, and/or
the blade field speeds acting on the rubber mixture during step C) in the mixing chamber of the second mixer lie in the range of 1 m/s to 80 m/s, preferably in the range of 3 m/s to 50 m/s, particularly preferably in the range of 3 m/s to 40 m/s, quite particularly preferably in the range of 5 m/s to 30 m/s.

In the context of the present invention, thus in the simplest case the blade field speeds arise from the product
of the shear speed of a rotor in a specific mixing chamber
and the circumferential length L running in the circumferential direction on the outer wall of the rotor blade at which the corresponding shear speeds are formed.

This arises from the following definitions:

The shear speeds, i.e. qualitatively how high the forces are at the maximum radius of the rotor blade, are preferably calculated in the context of the present invention according to the following formula 1:

$$\text{shear speed =} \text{v} / \text{h} \qquad \text{(formula 1)}$$

wherein
v = circulating speed of the rotor [⅟s] x maximum radius of the same rotor [mm] and
h = distance between the inner wall of the chamber housing and the outer wall of the rotor core of the same rotor [mm].

The quantity of forces arises from the area of a rotor blade of a rotor on which lies the maximum radius of the rotor as described above in formula 1. In rotor blades with a rectangular or trapezoid cross-section to the rotational axis of the corresponding rotor, this area corresponds to that the outer wall area of the rotor blade closest to the chamber housing:

$$\text{blade field speed = L} ⋅ \text{v} / \text{h} \qquad \text{(formula 2)}$$

wherein
v = circulating speed of the rotor [⅟s] x maximum radius of the same rotor [mm]
L = maximum circumferential length of the outer wall surface on which the maximum radius of the same rotor lies [m], and
h = distance between the inner wall of the chamber housing and the outer wall of the rotor core of the same rotor [mm].

In the context of the present invention, a rotor consists of a rotor core and one or more rotor blades.

In the context of the present invention, the radius of the rotor extends perpendicularly from the rotational axis of the rotor to the outermost point of the rotor blade, i.e. in the radial direction of the rotational axis of the rotor. The maximum radius of the rotor is the distance at which the distance between said rotational axis of the rotor and said radially outermost point of the rotor blade of the same rotor, i.e. the rotor blade tip, is greatest.

In the context of the present invention, the circumferential length of an outer surface of a rotor extends on the outer wall surface in the circumferential direction, wherein the maximum circumferential length of the outer surface of the rotor is the circumferential length which forms the longest extent on said outer surface in the circumferential direction. For a rectangular outer wall surface of a rotor blade, this often corresponds to the diagonal between two opposing corners of the outer wall surface.

Particular preference is given to a method as described above or as described above as preferred, wherein
the blade field speeds acting on the rubber mixture during step A) in the mixing chamber of the first mixer lie in the range of 20 m/s to 300 m/s, and
the blade field speeds acting on the rubber mixture during step C) in the mixing chamber of the second mixer lie in the range of 1 m/s to 80 m/s.

This increases the above-described dispersion of the fillers and the above-described homogeneity in the rubber mixture in comparison with a method as described above or as described above as preferred.

Quite particularly preferred is a method as described above, or as described above as preferred, wherein
the blade field speeds acting on the rubber mixture during step A) in the mixing chamber of the first mixer lie in the range of 20 m/s to 200 m/s, and
the blade field speeds acting on the rubber mixture during step C) in the mixing chamber of the second mixer lie in the range of 3 m/s to 50 m/s.

This increases the above-described dispersion of the fillers and the above-described homogeneity in the rubber mixture in comparison with a method as described above as particularly preferred.

In particular, quite particularly preferred is a method as described above, or as described above as preferred, wherein
the blade field speeds acting on the rubber mixture during step A) in the mixing chamber of the first mixer lie in the range of 30 m/s to 150 m/s, and
the blade field speeds acting on the rubber mixture during step C) in the mixing chamber of the second mixer lie in the range of 3 m/s to 30 m/s.

This increases the above-described dispersion of the fillers and the above-described homogeneity in the rubber mixture in comparison with a method as described above as quite particularly preferred.

In addition, in particular, quite particularly preferred is a method as described above, or as described above as preferred, wherein
the blade field speeds acting on the rubber mixture during step A) in the mixing chamber of the first mixer lie in the range of 30 m/s to 100 m/s, and
the blade field speeds acting on the rubber mixture during step C) in the mixing chamber of the second mixer lie in the range of 5 m/s to 30 m/s.

This increases the above-described dispersion of the fillers and the above-described homogeneity in the rubber mixture in comparison with a method as described above as in particular quite particularly preferred.

A method is preferred as described above, or as described above as preferred, wherein the second mixer has a supply unit for supplying rubber mixture constituents to the bottom chamber housing, preferably a supply unit for supplying vulcanization agents to the mixing chamber of the second mixer, wherein between steps A) to C), or during steps A) and/or C), vulcanization agents are transferred to the mixing chamber of the second mixer so that a non-vulcanized finished rubber mixture is produced during step C).

One advantage of the above-described aspect of the present invention is that on addition of vulcanization agents to the second mixing chamber, a finished rubber mixture is produced directly. With a method according to the invention as described above, it is possible to produce finished rubber mixtures which, because of the tandem mixing, can be produced in short time and simultaneously have a high dispersion of fillers and a high homogeneity of the rubber mixture.

Particularly greatly preferred is a method as described above comprising the following steps:
A) mixing of a rubber mixture in a first mixer, wherein the first mixer has a mixing chamber and at least one mixing rotor in the mixing chamber of the first mixer, wherein
   i. the mixing chamber of the first mixer has a first chamber volume,
   ii. the mixing chamber of the first mixer is delimited by a chamber housing, a first filling opening and a first ejection opening, and
   iii. the at least one mixing rotor of the first mixer has a mixing rotor core and at least two first rotor blades,
B) transfer of the rubber mixture mixed in the first mixer into a second mixer, wherein the second mixer has a mixing chamber and at least one mixing rotor in the mixing chamber of the second mixer, wherein
   iv. the mixing chamber of the second mixer is delimited by a chamber housing, a second filling opening and a second ejection opening,
   v. the mixing chamber of the second mixer has a second chamber volume, wherein the volume ratio of the chamber volume of the mixing chamber of the second mixer to the chamber volume of the mixing chamber of the first mixer lies in the range of 5:1 to 1.1:1, and
   vi. the at least one mixing rotor of the second mixer has a mixing rotor core and at least two second rotor blades,
C) mixing of the rubber mixture mixed in the first mixer in the second mixer, wherein the blade field speeds acting on the rubber mixture during step C) in the mixing chamber of the second mixer are lower than the blade field speeds acting on the rubber mixture during step A) in the mixing chamber of the first mixer,
wherein
the blade field speeds acting on the rubber mixture during step A) in the mixing chamber of the first mixer relative to the blade field speeds acting on the rubber mixture during step C) in the mixing chamber of the second mixer, lie in a range of 100:1 to 1:2,
the ratio of said first volume ratio to said second volume ratio lies in the range of 10:1 to 2:1,
the second mixer has a supply unit for supply of vulcanization agents to the mixing chamber of the second mixer, wherein between steps A) and C) or during step A) or C), vulcanization agents are transferred to the mixing chamber of the second mixer so that a non-vulcanized finished rubber mixture is produced in step C),
the silica proportion of the rubber mixture lies in the range of 40 phr to 200 phr and less than 0.1 phr soot is present in the rubber mixture,
the silane proportion of the rubber mixture lies in the range of 0.1 phr to 20 phr, and
the rubber mixture comprises at least one rubber selected from the group consisting of NR, IR, SBR, SSBR, and BR.

The above-described advantageous embodiments of a method according to the invention for producing a rubber mixture also apply to all embodiments of the use described below, and the advantageous embodiments discussed below of uses according to the invention apply accordingly to all embodiments of a method according to the invention for producing a rubber mixture.

The invention also concerns the use of a device for producing a rubber mixture, wherein the device is suitable for performance of a method as described above or as described above as preferred, and comprises the following components:
a first mixer comprising a mixing chamber with at least one first mixing rotor, wherein the mixing chamber of the first mixer
   has a first chamber volume, and
   is delimited by a chamber housing, a first filling opening and a first ejection opening,
   wherein each of the at least one first mixing rotors has a mixer rotor core and at least two first rotor blades, wherein the ratio of the total volume of all first rotor blades of all first mixing rotors to the mixing volume of the mixing chamber of the first mixer constitutes a first volume ratio, and
   a second mixer comprising a mixing chamber with at least one second mixing rotor, wherein the mixing chamber of the second mixer
   has a second chamber volume, and
   is delimited by a chamber housing, a second filling opening and a second ejection opening,
   wherein the at least one second mixing rotor has a mixer rotor core and at least two second rotor blades, wherein the ratio of the total volume of all second rotor blades of all second mixing rotors to the mixing volume of the mixing chamber of the second mixer constitutes a second volume ratio, wherein the ratio of the second chamber volume of the mixing chamber of the second mixer to the first chamber volume of the mixing chamber of the first mixer lies in the range of 15:1 to 1:1,characterized in that
   the ratio of said first volume ratio to said second volume ratio lies in the range of 50:1 to 1:10, preferably in the range of 20:1 to 1:1, preferably in the range of 15:1 to 1.1:1, particularly preferably in the range of 10:1 to 2:1.

Surprisingly, in the context of the present invention, it was found that the ratio of said first volume ratio to said second volume ratio improves the dispersion of fillers and/or the distribution of constituents in the rubber mixture.

Without wishing to be bound to a scientific theory, reference is made to the following in order to explain in more detail the above-described improvement of the dispersion of fillers and/or the distribution of constituents in the rubber mixture because of the use according to the invention:

As explained above, blade field speeds can be increased in qualitative or quantitative fashion. As already described likewise above, the quantity of the blade field speeds is dependent on the size of said area of the outer wall of a rotor blade, as shown in formula 2 above, and the quality of the blade field speeds depends amongst others on the maximum radius of the rotor on said area of the outer wall, as described above in formula 1; both above-described parameters, i.e. both the size of the area of the outer wall and also the maximum radius of the rotor, and hence the distance of the outer wall of the rotor blade to the inner wall of the respective chamber housing, are geometric factors of the arrangement of mixing rotors to the respective chamber housing of the mixing chamber in which said mixing rotors are located. These geometric factors are defined combined for the first mixing chamber, in the context of the present invention, in the first volume ratio and for the second mixing chamber, in the context of the present invention, in the second volume ratio. In other words, the above-described first volume ratio and similarly the above-described second volume ratio set the volume of all rotor blades in relation to the mixing volume of the corresponding mixing chamber in which the corresponding rotor blades are located. The greater the volume of a rotor blade in comparison with the corresponding mixing chamber,
the closer said outer wall of the rotor blade lies to the inner wall of the chamber housing of the corresponding mixing chamber, i.e. the greater the maximum radius of the rotor and the greater the shear speeds according to the above formula 1, and/or
the greater is said area of the outer wall of the rotor blade and hence the quantity of the blade field speeds according to the above formula 2.

The linking of said improved dispersion of fillers and improved distribution of constituents in the rubber mixture with the above-described volume ratio is a particular feature of the present invention.

In addition, in the context of the present invention, it has been found that the above-mentioned ratio of the first volume ratio to the second volume ratio of a device according to the invention, in particular a tandem mixer, can be increased since a greater quantity of rubber mixture can be achieved per mixing cycle in relation to the overall device according to the invention. This applies to both silica-containing and soot-containing rubber mixtures.

In the context of the present invention, the mixing volume of a mixing chamber is the chamber volume of the corresponding mixing chamber minus the volume taken up by all rotor cores in the corresponding mixing chamber. The mixing volume of a mixing chamber in the context of the present invention thus corresponds to the volume in which a rubber mixture may be present or moved in the corresponding mixing chamber.

The use is preferred as described above, or as described above as preferred, wherein the rubber mixture comprises silica, wherein the silica proportion of the rubber mixture preferably lies in the range of 1 phr to 200 phr and/or less than 0.1 phr soot is present in the rubber mixture, particularly preferably the silica proportion lies in the range of 40 phr to 190 phr, quite particularly preferably the silica proportion lies in the range of 60 phr to 180 phr, in particular quite particularly preferably the silica proportion lies in the range of 90 phr to 170 phr.

An advantage of the above-described aspect of the present invention is that, in particular for silica mixtures, particularly great increases can be achieved in the dispersion of the silica and the distribution of the remaining constituents in the rubber mixture. This applies in particular for silica mixtures with the above-described preferred silica proportions.

The use is preferred as described above, or as described above as preferred, wherein the rubber mixture comprises one or more silanes, wherein the silane proportion of the rubber mixture preferably lies in the range of 0.01 phr to 50 phr, particularly preferably the silane proportion lies in the range of 0.1 phr to 40 phr, quite particularly preferably the silane proportion lies in the range of 1 phr to 30 phr, in particular quite particularly preferably the silane proportion lies in the range of 3 phr to 20 phr.

An advantage of the above-described aspect of the present invention is that, in particular for silica mixtures, particularly great increases can be achieved in the distribution of the silane in the rubber mixture. This applies in particular for silica mixtures with the above-described preferred silane proportions.

The use is preferred as described above, or as described above as preferred, wherein the rubber mixture comprises at least one rubber selected from the group consisting of IIR, EPDM, NR, IR, SBR, SSBR and BR.

It is an advantage of the above-described aspect of the present invention that, in particular for rubber mixtures with the above-described rubber types, the above-described problems of the prior art are particularly pronounced.

The use is preferred as described above, or as described above as preferred, wherein the volume ratio of the second chamber volume of the mixing chamber of the second mixer to the first chamber volume of the mixing chamber of the first mixer lies in the range of 14:1 to 1.1:1, preferably in the range of 10:1 to 1.5:1, particularly preferably in the range of 5:1 to 2:1.

It is an advantage of the above-described aspect of the present invention that, in conjunction with the above-described ratio of said first volume ratio to said second volume ratio, greater blade field speeds occur in the first mixing chamber in comparison with the second mixing chamber, and hence not only do the above-described advantages apply with respect to improved homogeneity and dispersion, but also greater quantities of rubber mixtures can be achieved per cycle in a device according to the invention.

The use is preferred as described above, or as described above as preferred, wherein the ratio of said first volume ratio to said second volume ratio lies in the range of 5:1 to 1:10, preferably in the range of 1:1 to 1:10, particularly preferably in the range of 1:1.01 to 1:10.

It is an advantage of the above-described aspect of the present invention that even greater quantities of rubber mixtures can be achieved per cycle in a device according to the invention in comparison with the volume ratio as described above. In addition and independently of the achieved quantity of rubber mixture per cycle, a better temperature control could be achieved in the second mixing chamber, whereby an even better said homogeneity could be achieved in the rubber mixture.

The use is preferred as described above, or as described above as preferred, wherein each first rotor blade of all mixing rotors in the first mixer has a first aspect ratio, wherein the first aspect ratio formed from the height of one of the first rotor blades, preferably each first rotor blade, to the effective diameter of said first rotor blade, preferably the corresponding first rotor blade of all first rotor blades, lies in the range of 50:1 to 1:10, preferably in the range of 20:1 to 1.01:1, particularly preferably in the range of 15:1 to 1.1:1, quite particularly preferably in the range of 10:1 to 2:1, in particular quite particularly preferably in the range of 8:1 to 5:1, wherein preferably the minimum distance between the rotor blade tip of a first rotor blade, preferably each first rotor blade, to the inner wall of the first mixer lies in the range of 0.4 to 2.0 cm, preferably in the range of 0.6 cm to 1.5 cm, particularly preferably in the range of 0.7 to 0.9 cm.

It is an advantage of the above-described aspect of the present invention that because of the above conditions, a better dispersion of filler in the rubber mixture resulting from the first mixing chamber is achieved.

In the context of the present invention, the height of a rotor blade extends along the radial direction of the rotor of said rotor blade, and is the distance from the outer wall of the rotor core to the rotor blade tip or the outer wall of said rotor blade, wherein the height of a rotor blade is preferably the maximum radius of a rotor as defined in the above formula 1.

In the context of the present invention, the effective diameter of a rotor blade is defined in the following formula 3:

$$\text{effective diameter =} {\text{V}}_{\text{Fl} \ddot{\text{u}} \text{gel}} / \left(π {\text{r}}^{2}\right) \qquad \text{(formula 3)}$$

wherein
r = half the height of the rotor blade or blades concerned, and
V_{Flügel} = volume of the rotor blade or blades concerned, wherein the volume of a cuboid rotor blade is calculated from the product of the mutually orthogonal side edge lengths according to mathematical geometry teaching, and the volume of a frustopyramidal rotor blade is calculated from the height of the rotor blade, the base area and the outer wall of the rotor blade according to mathematical geometry teaching. Other volumes of three-dimensional rotor blades are calculated according to their geometric form according to mathematical geometry teaching.

In the context of the present invention, the base area of a specific rotor blade of a rotor is the interface between the rotor core of the same rotor and the specific rotor blade of the one rotor.

The use is preferred as described above, or as described above as preferred, wherein each second rotor blade of all mixing rotors in the second mixer has a second aspect ratio, wherein the second aspect ratio formed from the height of one of the second rotor blades, preferably each second rotor blade, to the effective diameter of said second rotor blade, preferably the corresponding second rotor blade of all second rotor blades, lies in the range of 50:1 to 1:10, preferably in the range of 20:1 to 1:10, particularly preferably in the range of 5:1 to 1:10, quite particularly preferably in the range of 2:1 to 1:5, in particular quite particularly preferably in the range of 1:1 to 1:2.

It is an advantage of the above-described aspect of the present invention that because of the above conditions, a better homogeneity of the rubber mixture resulting from the second mixing chamber is achieved.

The use is preferred as described above, or as described above as preferred, wherein the ratio of the first aspect ratio to the second aspect ratio lies in the range of 100:1 to 1:10, preferably in the range of 50:1 to 1.01:1, particularly preferably in the range of 20:1 to 1.1:1, quite particularly preferably in the range of 20:1 to 2:1, in particular quite particularly preferably in the range of 10:1 to 5:1.

An advantage of the above-described aspect of the present invention is that in the range of 100:1 to 1:10, sufficiently high blade field speeds can be achieved with maximum said homogeneity and maximum efficiency, as described above, in a device according to the invention.

The smaller the second rotor blades and hence the higher however the above-described ratio, the greater said homogeneity of the resulting rubber mixture. This applies in particular for ratios of the first aspect ratio to the second aspect ratio in the range of 100:1 to 1.01:1, particularly preferably in the range of 100:1 to 1.1:1, quite particularly preferably in the range of 100:1 to 2:1, in particular quite particularly preferably in the range of 100:1 to 5:1.

The use is particularly preferred as described above, or as described above as preferred, wherein the ratio of the minimum distance between the or all rotor blade tips of a first rotor blade and the inner wall of the chamber housing of the first mixer to the minimum distance between the or all rotor blade tips of a second rotor blade and the inner wall of the chamber housing of the second mixer lies in the range of 10:1 to 1:50, preferably in the range of 5:1 to 1:20, particularly preferably in the range of 1:1 to 1:8, quite particularly preferably in the range of 1:1.1 to 1:2, wherein preferably
the minimum distance between the or all rotor blade tips of a second rotor blade and the inner wall of the chamber housing of the second mixer lies between 0.8 and 5.0 cm, preferably in the range of 1.0 to 5 cm, particularly preferably in the range of 1.0 to 2.0 cm, quite particularly preferably in the range of 1.2 to 2.0 cm, and/or
the minimum distance between the rotor blade tips of a second rotor blade, preferably each second rotor blade, and the outer wall of the mixing rotor core of the other mixing rotor of the second mixer lies between 1.0 and 5.0 cm, preferably in the range of 1.5 to 5.0 cm, particularly preferably in the range of 1.5 to 3.0 cm, quite particularly preferably in the range of 2.0 to 3.0 cm.

It is an advantage of the above-described aspect of the present invention that the blade field speeds in the first mixing chamber are increased even further in comparison with the blade field speeds in the second mixing chamber. As described above, this increases said dispersion and/or said homogeneity even further in comparison with the above-described preferred uses of the present invention.

In the context of the present invention, the minimum distance between the or all rotor blade tips of a rotor blade of a rotor and the inner wall of the chamber housing in which said rotor with said one or all rotor blade tips is arranged, is the smallest distance from said chamber housing to said rotor on a revolution about its rotational axis.

The use is particularly preferred as described above, or as described above as preferred, wherein the first and second mixers each have two mixing rotors, wherein the ratio
of the minimum distance between the rotor blade tip of a first rotor blade, preferably each first rotor blade, of a mixing rotor of the first mixer and the outer wall of the mixing rotor core of the other mixing rotor of the first mixer,
to the minimum distance between the rotor blade tip of a second rotor blade, preferably each second rotor blade, of a mixing rotor of the second mixer and the outer wall of the mixing rotor core of the other mixing rotor of the second mixer,
lies in the range of 50:1 to 1.01:1, preferably in the range of 20:1 to 1.1:1, particularly preferably in the range of 20:1 to 2:1, quite particularly preferably in the range of 10:1 to 5:1,
wherein preferably
   the minimum distance between the rotor blade tip of a first rotor blade, preferably each first rotor blade, and the outer wall of the mixing rotor core of the other mixing rotor of the first mixer lies in the range of 0.6 to 2.0 cm, preferably in the range of 0.8 cm to 1.5 cm, particularly preferably in the range of 1.0 to 1.5 cm, quite particularly preferably in the range of 1.2 to 1.5 cm, and/or
   the minimum distance between the rotor blade tips of a second rotor blade, preferably each second rotor blade, and the outer wall of the mixing rotor core of the other mixing rotor of the second mixer lies in the range from 1.0 to 5.0 cm, preferably in the range of 1.5 to 5.0 cm, particularly preferably in the range of 1.5 to 3.0 cm, quite particularly preferably in the range of 2.0 to 3.0 cm.

In the context of the present invention, the minimum distance between a rotor blade tip in a mixing chamber and the outer wall of the mixing rotor core of the other mixing rotor of the same mixing chamber, is the smallest distance of the outer wall of the mixing rotor core of the other mixing rotor from said rotor blade tip on its revolution about the rotational axis of the rotor.

It is an advantage of the above-described aspect of the present invention that the blade field speeds in the first mixing chamber are increased even further in comparison with the blade field speeds in the second mixing chamber, since now also the above blade field speeds which act between the different rotors of a mixing chamber were taken into account in addition to the blade field speeds between the individual rotors and the inner wall of the chamber housing of the corresponding mixer. This increases said dispersion and/or said homogeneity even further in comparison with the uses of the present invention described above as preferred or as particularly preferred.

The use is preferred as described above, or as described above as preferred, wherein all mixing rotors of the first mixer are intermeshing rotors, and/or all mixing rotors of the second mixer are intermeshing rotors.

It is an advantage of the above-described aspect of the present invention that in this way, even higher blade field speeds can be achieved in the above-described first mixer, while in the second mixer an even better distribution of constituents in the rubber mixture and hence an even greater homogeneity as described above can be achieved.

Preference is given to the use as described above or as described above as preferred, wherein
the first mixer has a ram and/or the second mixer has no ram, and/or
the first mixer is a top mixer and the second mixer a bottom mixer of a tandem mixer.

It is an advantage of the above-described aspect of the present invention that the device according to the invention is a tandem mixer and hence a clear reduction in cost per cycle is achieved, in which in the context of the present invention, particularly great increases are achieved in said homogeneity and/or said dispersion.

To a particularly great extent, the use is preferred as described above wherein the device is suitable for performance of a method as claimed in any of the preceding claims and comprises the following components:
a first mixer comprising a mixing chamber with at least one first mixing rotor, wherein the mixing chamber of the first mixer
   has a first chamber volume, and
   is delimited by a chamber housing, a first filling opening and a first ejection opening,
   wherein each of the at least one first mixing rotors has a mixing rotor core and at least two first rotor blades, wherein the ratio of the total volume of all first rotor blades of all first mixing rotors to the mixing volume of the mixing chamber of the first mixer constitutes a first volume ratio, and
   a second mixer comprising a mixing chamber with at least one second mixing rotor, wherein the mixing chamber of the second mixer
   has a second chamber volume, and
   is delimited by a chamber housing, a second filling opening and a second ejection opening,
   wherein the at least one second mixing rotor has a mixer rotor core and at least two second rotor blades, wherein the ratio of the total volume of all second rotor blades of all second mixing rotors to the mixing volume of the mixing chamber of the second mixer constitutes a second volume ratio, wherein the volume ratio of the second chamber volume of the mixing chamber of the second mixer to the first chamber volume of the mixing chamber of the first mixer lies in the range of 5:1 to 1.1:1,
characterized in that
the ratio of said first volume ratio to said second volume ratio lies in the range of 10:1 to 2:1, wherein
each first rotor blade of all mixing rotors in the first mixer has a first aspect ratio, wherein the first aspect ratio formed from the height of a first rotor blade to the effective diameter of said first rotor blade lies in the range of 10:1 to 2:1,
each second rotor blade of all mixing rotors in the second mixer has a second aspect ratio, wherein the second aspect ratio formed from the height of a second rotor blade to the effective diameter of said second rotor blade lies in the range of 1:1 to 1:5,
the ratio of said first aspect ratio to said second aspect ratio lies in the range of 20:1 to 1.01:1,
the ratio of the minimum distance between the rotor blade tip of a first rotor blade and the inner wall of the chamber housing of the first mixer, to the minimum distance between the rotor blade tip of a second rotor blade and the inner wall of the chamber housing of the first mixer, lies in the range of 20:1 to 1.1:1,
the first and second mixers each have two mixing rotors, wherein the ratio of the minimum distance between the rotor blade tip of a first rotor blade of a mixing rotor of the first mixer and the outer wall of the mixing rotor core of the other mixing rotor of the first mixer, to the minimum distance between the rotor blade tip of a second rotor blade of a mixing rotor of the second mixer and the outer wall of the mixing rotor core of the other mixing rotor of the second mixer, lies in the range of 20:1 to 1.1:1,
the first rotor blades are intermeshing rotors, and the second rotor blades of the two lower mixer rotors are intermeshing rotors,
the first mixer has a ram and/or the second mixer has no ram, and
the first mixer is a top mixer and the second mixer a bottom mixer of a tandem mixer.

The present invention will be described below with reference to further aspects. The above-described advantageous embodiments of the use according to the invention and a method according to the invention also apply to all aspects of a device described below, and the advantageous aspects discussed below of devices according to the invention apply accordingly to all embodiments of the use according to the invention and a method according to the invention, wherein the term “top mixer” is synonymous with the term “first mixer”, and the term “bottom mixer” is synonymous with the term “second mixer”.

### First Aspect

1. A device for producing a rubber mixture, comprising
a top mixer with at least two top mixer rotors, wherein the top mixer is delimited by a top chamber housing, a first filling opening and a first ejection opening, wherein the top mixer rotors of a top mixer rotor core have at least two first rotor blades, wherein the ratio of the total volume of all first rotor blades to the effective volume of the top chamber housing constitutes a first volume ratio, and
a bottom mixer with at least two bottom mixer rotors, wherein the bottom mixer is delimited by a bottom chamber housing, a second filling opening and a second ejection opening, wherein the bottom mixer rotors of a bottom mixer rotor core have at least two second rotor blades, wherein the ratio of the total volume of all second rotor blades to the effective volume of the bottom chamber housing constitutes a second volume ratio,
characterized in that

the ratio of said first volume ratio to said second volume ratio lies in the range of 50:1 to 1:10, preferably in the range of 20:1 to 1:1, preferably in the range of 15:1 to 1.1:1, particularly preferably in the range of 10:1 to 2:1.

2. The device according to aspect 1, wherein the ratio of the second chamber volume of the mixing chamber of the second mixer to the first chamber volume of the mixing chamber of the first mixer lies in the range of 15:1 to 1:1, preferably in the range of 14:1 to 1.1:1, particularly preferably in the range of 10:1 to 1.5:1, quite particularly preferably in the range of 5:1 to 2:1.

3. The device according to either of the preceding aspects, wherein
a first aspect ratio formed from the height of one of the first rotor blades to the effective diameter of said first rotor blade lies in the range of 50:1 to 1:10, preferably in the range of 20:1 to 1.01:1, particularly preferably in the range of 15:1 to 1.1:1, quite particularly preferably in the range of 10:1 to 2:1, in particular quite particularly preferably in the range of 8:1 to 5:1, and/or
a second aspect ratio formed from the height of one of the second rotor blades to the effective diameter of said second rotor blade lies in the range of 50:1 to 1:10, preferably in the range of 20:1 to 1:10, particularly preferably in the range of 5:1 to 1:10, quite particularly preferably in the range of 2:1 to 1:5, in particular quite particularly preferably in the range of 1:1 to 1:2.

4. The device according to any of the preceding aspects, wherein the ratio of the first aspect ratio to the second aspect ratio lies in the range of 100:1 to 1:10, preferably in the range of 50:1 to 1.01:1, particularly preferably in the range of 20:1 to 1.1:1, quite particularly preferably in the range of 20:1 to 2:1, in particular quite particularly preferably in the range of 10:1 to 5:1.

5. The device according to any of the preceding aspects, wherein the ratio of the minimum distance between the rotor blade tip of a first rotor blade and the inner wall of the top chamber housing to the minimum distance between the rotor blade tip of a second rotor blade and the inner wall of the bottom chamber housing lies in the range of 10:1 to 1:50, preferably in the range of 5:1 to 1:20, particularly preferably in the range of 1:1 to 1:8, quite particularly preferably in the range of 1:1.1 to 1:2.

6. The device according to any of the preceding aspects, wherein the ratio of the minimum distance between the rotor blade tip of a first rotor blade and the outer wall of the top mixer rotor core to the minimum distance between the rotor blade tip of a second rotor blade and the outer wall of the bottom mixer rotor core lies in the range of 50:1 to 1.01:1, preferably in the range of 20:1 to 1.1:1, particularly preferably in the range of 20:1 to 2:1, quite particularly preferably in the range of 10:1 to 5:1.

7. The device according to any of the preceding aspects, wherein the rotor blades of the two top mixer rotors are intermeshing rotors, and/or the rotor blades of the two bottom mixer rotors are intermeshing rotors.

8. The device according to any of the preceding aspects, wherein the device comprises a supply unit for the supply of rubber mixture constituents to the bottom chamber housing, preferably a supply unit for supplying vulcanization agents to the bottom chamber housing.

9. The device according to any of the preceding aspects, wherein
the top mixer has a ram and/or the bottom mixer has no ram, and/or
the first mixer is a top mixer and the second mixer a bottom mixer of a tandem mixer.

10. A method for producing non-vulcanized vehicle tire components and/or a vehicle tire, comprising the following steps:
i. production or provision of rubber mixture constituents,
ii. mixing of the rubber mixture constituents produced and/or provided in step A) in the top mixer of a device according to any of the preceding aspects into a base rubber mixture,
iii. mixing of the base rubber mixture produced in step B) with vulcanization agents and optionally further rubber mixture constituents in the bottom mixer of a device according to any of the preceding aspects, so that a finished rubber mixture is produced,
iv. shaping and cutting of the finished rubber mixture so that non-vulcanized vehicle tire components are produced, and optionally
v. vulcanizing of one or more of the vehicle tire components together with further tire components so that a vehicle tire is produced.

11. The use of the device according to any of the preceding aspects for producing a finished rubber mixture or a vehicle tire component.

12. A method for producing a rubber mixture, comprising the following steps:
A) mixing of a rubber mixture in a first mixer, wherein the first mixer has a mixing chamber and at least one mixing rotor in the mixing chamber of the first mixer, wherein
   i. the mixing chamber of the first mixer has a first chamber volume,
   ii. the mixing chamber of the first mixer is delimited by a chamber housing, a first filling opening and a first ejection opening, and
   iii. the at least one mixing rotor (1) of the first mixer has a mixing rotor core (2) and at least two first rotor blades (3a, 3b),
B) transfer of the rubber mixture mixed in the first mixer into a second mixer, wherein the second mixer has a mixing chamber and at least one mixing rotor (1) in the mixing chamber of the second mixer, wherein
   i. the mixing chamber of the second mixer is delimited by a chamber housing, a second filling opening and a second ejection opening,
   ii.the mixing chamber of the second mixer has a second chamber volume, wherein the volume ratio of the chamber volume of the mixing chamber of the second mixer to the chamber volume of the mixing chamber of the first mixer lies in the range of 15:1 to 1:1, and
   iii. the at least one mixing rotor (1) of the second mixer has a mixing rotor core (2) and at least two second rotor blades (3a, 3b),
C) mixing of the rubber mixture mixed in the first mixer in the second mixer, wherein the blade field speeds acting on the rubber mixture during step C) in the mixing chamber of the second mixer are lower than the blade field speeds acting on the rubber mixture during step A) in the mixing chamber of the first mixer.

13. The method according to aspect 12, wherein
the ratio of the blade field speeds acting on the rubber mixture during step A) in the mixing chamber of the first mixer to the blade field speeds acting on the rubber mixture during step C) in the mixing chamber of the second mixer lies in the range of 1 000 000:1 to 1.01:1, preferably in the range of 100 000:1 to 5:1, particularly preferably in the range of 10 000:1 to 10:1, quite particularly preferably in the range of 500:1 to 100:1, and/or
the blade field speeds acting on the rubber mixture during step A) in the mixing chamber of the first mixer lie in the range of 10 m/s to 300 m/s, preferably in the range of 20 m/s to 200 m/s, particularly preferably in the range of 30 m/s to 150 m/s, quite particularly preferably in the range of 40 m/s to 100 m/s, and/or
the blade field speeds acting on the rubber mixture during step C) in the mixing chamber of the second mixer lie in the range of 1 m/s to 80 m/s, preferably in the range of 3 m/s to 50 m/s, particularly preferably in the range of 3 m/s to 30 m/s, quite particularly preferably in the range of 5 m/s to 30 m/s.

14. The method according to any of the preceding aspects 12 and 13, wherein the second mixer has a supply unit for supplying rubber mixture constituents to the bottom chamber housing, preferably a supply unit for supplying vulcanization agents to the mixing chamber of the second mixer, wherein between steps A) to C), or during steps A) and/or C), vulcanization agents are transferred to the mixing chamber of the second mixer so that a non-vulcanized finished rubber mixture is produced during step C).

15. The use of a device for producing a rubber mixture, which comprises the following components:
a first mixer comprising a mixing chamber with at least one first mixing rotor (1), wherein the mixing chamber of the first mixer
   has a first chamber volume, and
   is delimited by a chamber housing, a first filling opening and a first ejection opening,
   wherein each of the at least one first mixing rotors (1) has a mixing rotor core (2) and at least two first rotor blades (3a, 3b), wherein the ratio of the total volume of all first rotor blades (3a, 3b) of all first mixing rotors (1) to the mixing volume of the mixing chamber of the first mixer (1) constitutes a first volume ratio, and
a second mixer comprising a mixing chamber with at least one second mixing rotor (1), wherein the mixing chamber of the second mixer
   has a second chamber volume, and
   is delimited by a chamber housing, a second filling opening and a second ejection opening,
   wherein the at least one second mixing rotor (1) has a mixer rotor core (2) and at least two second rotor blades (3a, 3b), wherein the ratio of the total volume of all second rotor blades (3a, 3b) of all second mixing rotors (1) to the mixing volume of the mixing chamber of the second mixer constitutes a second volume ratio, wherein the ratio of the second chamber volume of the mixing chamber of the second mixer to the first chamber volume of the mixing chamber of the first mixer lies in the range of 15:1 to 1:1,
characterized in that

the ratio of said first volume ratio to said second volume ratio lies in the range of 50:1 to 1:10, preferably in the range of 20:1 to 1:1, preferably in the range of 15:1 to 1.1:1, particularly preferably in the range of 10:1 to 2:1.

16. The use according to aspect 15 or method according to any of the preceding aspects 1 to 3, wherein the rubber mixture comprises silica, wherein the silica proportion of the rubber mixture preferably lies in the range of 1 phr to 200 phr and/or less than 0.1 phr soot is present in the rubber mixture, particularly preferably the silica proportion lies in the range of 40 phr to 190 phr, quite particularly preferably the silica proportion lies in the range of 60 phr to 180 phr, in particular quite particularly preferably the silica proportion lies in the range of 90 phr to 170 phr.

17. The use according to any of the preceding aspects 15 to 16 or method according to any of the preceding aspects 1 to 3, wherein the rubber mixture comprises one or more silanes, wherein the silane proportion of the rubber mixture preferably lies in the range of 0.01 phr to 50 phr, particularly preferably the silane proportion lies in the range of 0.1 phr to 40 phr, quite particularly preferably the silane proportion lies in the range of 1 phr to 30 phr, in particular quite particularly preferably the silane proportion lies in the range of 3 phr to 20 phr.

18. The use according to any of the preceding aspects 15 to 17, wherein the rubber mixture comprises at least one rubber selected from the group consisting of IIR, EPDM, NR, IR, SBR, SSBR and BR.

19. The use according to any of the preceding aspects 15 to 18, wherein the volume ratio of the second chamber volume of the mixing chamber of the second mixer to the first chamber volume of the mixing chamber of the first mixer lies in the range of 14:1 to 1.1:1, preferably in the range of 10:1 to 1.5:1, particularly preferably in the range of 5:1 to 2:1.

20. The use according to any of the preceding aspects 15 to 19, wherein the ratio of said first volume ratio to said second volume ratio lies in the range of 5:1 to 1:10, preferably in the range of 1:1 to 1:10, particularly preferably in the range of 1:1.01 to 1:10.

21. The use according to any of the preceding aspects 15 to 20, wherein
at least one first rotor blade (3a, 3b) or each first rotor blade (3a, 3b) of all mixing rotors (1) in the first mixer has a first aspect ratio, wherein the first aspect ratio formed from the height of one of the first rotor blades (3a, 3b) to the effective diameter of said one first rotor blade (3a, 3b) lies in the range of 50:1 to 1:10, preferably in the range of 20:1 to 1.01:1, particularly preferably in the range of 15:1 to 1.1:1, quite particularly preferably in the range of 10:1 to 2:1, in particular quite particularly preferably in the range of 8:1 to 5:1, and/or
at least one second rotor blade (3a, 3b) or each second rotor blade (3a, 3b) of all mixing rotors (1) in the second mixer has a second aspect ratio, wherein the second aspect ratio formed from the height of one of the second rotor blades (3a, 3b) to the effective diameter of said one second rotor blade (3a, 3b) lies in the range of 50:1 to 1:10, preferably in the range of 20:1 to 1:10, particularly preferably in the range of 5:1 to 1:10, quite particularly preferably in the range of 2:1 to 1:5, in particular quite particularly preferably in the range of 1:1 to 1:2.

22. The use according to any of the preceding aspects 15 to 21, wherein the ratio of the first aspect ratio to the second aspect ratio lies in the range of 100:1 to 1:10, preferably in the range of 50:1 to 1.01:1, particularly preferably in the range of 20:1 to 1.1:1, quite particularly preferably in the range of 20:1 to 2:1, in particular quite particularly preferably in the range of 10:1 to 5:1.

23. The use according to any of the preceding aspects 15 to 22, wherein the ratio of the minimum distance between the rotor blade tip (4) of a first rotor blade (3a, 3b) and the inner wall of the chamber housing of the first mixer to the minimum distance between the rotor blade tip (4) of a second rotor blade (3a, 3b) and the inner wall of the chamber housing of the second mixer lies in the range of 10:1 to 1:50, preferably in the range of 5:1 to 1:20, particularly preferably in the range of 1:1 to 1:8, quite particularly preferably in the range of 1:1.1 to 1:2.

24. The use according to any of the preceding aspects 15 to 23, wherein the first and second mixer each have two mixing rotors (1), wherein the ratio of the minimum distance between the rotor blade tip (4) of a first rotor blade (3a, 3b) of a mixing rotor (1) of the first mixer and the outer wall (10) of the mixing rotor core (2) of the other mixing rotor (1) of the first mixer to the minimum distance between the rotor blade tip (4) of a second rotor blade (3a, 3b) of a mixing rotor (1) of the second mixer and the outer wall (10) of the mixing rotor core (2) of the other mixing rotor (1) of the second mixer lies in the range of 50:1 to 1.01:1, preferably in the range of 20:1 to 1.1:1, particularly preferably in the range of 20:1 to 2:1, quite particularly preferably in the range of 10:1 to 5:1.

25. The use according to any of the preceding aspects 15 to 24 wherein all mixing rotors (1) of the first mixer are intermeshing rotors, and/or all mixing rotors (1) of the second mixer are intermeshing rotors.

26. The use according to any of the preceding aspects 15 to 25, wherein
the first mixer has a ram and/or the second mixer has no ram, and/or
the first mixer is a top mixer and the second mixer a bottom mixer of a tandem mixer.

### DESCRIPTION OF THE FIGURES

In the figures:

FIG. 1: shows a perspective view of a rotor of a device according to the invention, wherein two sections A-A and B-B are drawn in FIG. 1;

FIG. 2: shows a cross-sectional view along section A-A of the device according to the invention shown in FIG. 1;

FIG. 3: shows a cross-sectional view along section B-B of the device according to the invention shown in FIG. 1.

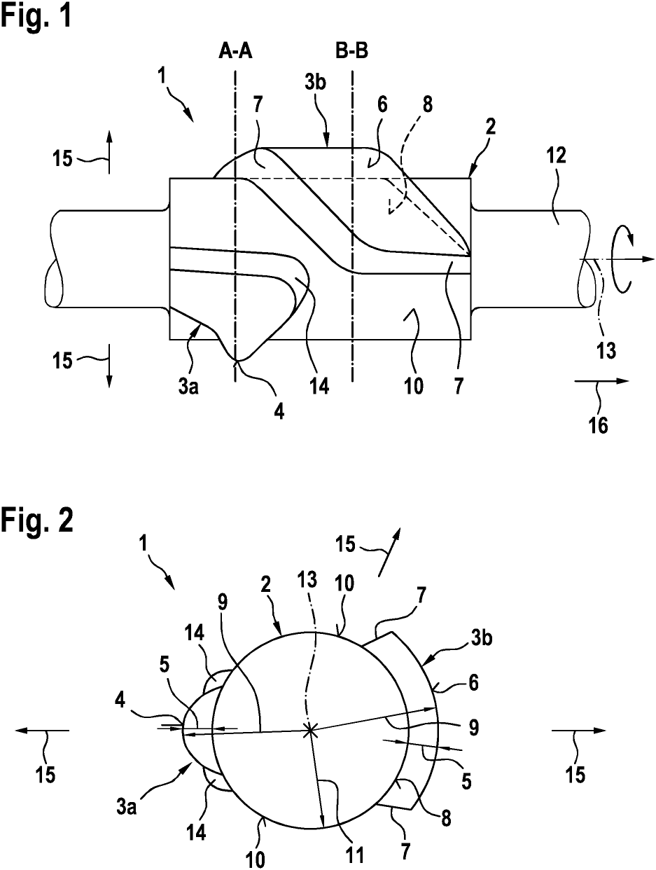

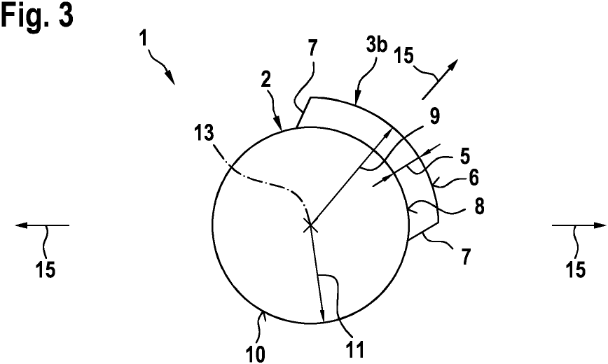

FIG. 1 shows a rotor as roughly depicted in FIG. 3 of document DE 4129108 A1. With reference to the rotor 1 illustrated schematically in FIG. 1, the various aspects of the present invention will be explained as examples in detail. The rotor 1 illustrated schematically in FIG. 1 has an axis 12, a rotational axis 13, a mixer rotor core 2 with an outer surface 10 and two rotor blades 3a, 3b. The rotor blade 3a running to a tip in the radial direction 15 has a clearly defined rotor blade tip 4 and a weld seam 14. The frustopyramidal rotor blade 3b has an outer wall 6 with an outer surface, a base surface 8 and several side walls 7, wherein the base surface 8 of the rotor blade 3b of the rotor 1 is the surface which lies against the rotor core 2 of the rotor 1.

In the context of the present invention, the outer surface of the outer wall of the rotor blade, in semi-circular or similarly shaped rotor blades, corresponds precisely to the surface which adjoins the line lying on said outer surface which has the smallest distance from the inner wall of the chamber housing, and the distance from the inner wall of the chamber housing is only up to 0.5 mm greater than said line.

FIG. 2 shows a schematically illustrated cross-sectional view along section A-A of the device according to the invention shown in FIG. 1. The rotor 1 shown in FIG. 1 has a rotational axis 13, a mixer rotor core 2 with an outer surface 10 and a radius 11, and two rotor blades 3a, 3b. The pointed-tip rotor blade 3a has a clearly defined rotor blade tip 4 and a weld seam 14 and a height 5. The frustopyramidal rotor blade 3b has an outer wall 6 with an outer surface, a base surface 8 and several side walls 7 and a height 5, wherein the base surface 8 of the rotor blade 3b of the rotor 1 is the surface which lies against the rotor core 2 of the rotor 1. The maximum radius 9 of the rotor 2 extends in the radial direction 15 from the rotational axis to the rotor blade tip 4 of the rotor blade 3a, and in the radial direction 15 from the rotational axis to the outer surface 10 of the rotor blade 3b.

FIG. 3 shows a schematically illustrated cross-sectional view along section B-B of the device according to the invention shown in FIG. 1. The rotor 1 shown in FIG. 2 has a rotational axis 13, a mixer rotor core 2 with an outer surface 10 and a radius 11, and the rotor blade 3b. The frustopyramidal rotor blade 3b has an outer wall 6 with an outer surface, a base surface 8 and several side walls 7 and a height 5, wherein the base surface 8 of the rotor blade 3b of the rotor 1 is the surface which lies against the rotor core 2 of the rotor 1. The maximum radius 9 of the rotor 2 extends in the radial direction 15 from the rotational axis to the outer surface 10 of the rotor blade 3b.

List of reference signs:

| | |
|---|---|
| 1 | Mixing rotor |
| 2 | Mixing rotor core; rotor core |
| 3 a | Pointed-tip rotor blade with clearly defined rotor blade tip |
| 3 b | Frustopyramidal rotor blade with outer face on which the maximum radius of the rotor lies |
| 4 | Rotor blade tip of a rotor blade; radially outermost point of the rotor blade |
| 5 | Height of a rotor blade |
| 6 | Outer wall or outer face of the rotor blade; outer face on which the maximum radius of a rotor lies |
| 7 | Side wall of the rotor blade |
| 8 | Base surface of the rotor blade |
| 9 | Maximum radius of a rotor |
| 10 | Outer face or face of the outer wall of the mixing rotor core |
| 11 | Radius of the rotor core |
| 12 | Rotor axis |
| 13 | Rotational axis of the rotor |
| 14 | Weld seam |
| 15 | Radial direction; perpendicular to axial direction |
| 16 | Axial direction; perpendicular to radial direction |

1-15. (canceled)

16. A device for producing a rubber mixture, the device comprising:
a first mixer comprising a mixing chamber with at least one first mixing rotor (1), wherein the mixing chamber of the first mixer has a first chamber volume, and is delimited by a chamber housing, a first filling opening and a first ejection opening,
wherein each of the at least one first mixing rotors (1) comprises a mixer rotor core (2) and at least two first rotor blades (3a, 3b), wherein the ratio of the total volume of all first rotor blades (3a, 3b) of all first mixing rotors (1) to the mixing volume of the mixing chamber of the first mixer (1) constitutes a first volume ratio, and
a second mixer comprising a mixing chamber with at least one second mixing rotor (1), wherein the mixing chamber of the second mixer has a second chamber volume, and is delimited by a chamber housing, a second filling opening and a second ejection opening,
wherein the at least one second mixing rotor (1) has a mixer rotor core (2) and at least two second rotor blades (3a, 3b), wherein the ratio of the total volume of all second rotor blades (3a, 3b) of all second mixing rotors (1) to the mixing volume of the mixing chamber of the second mixer constitutes a second volume ratio, wherein the ratio of the second chamber volume of the mixing chamber of the second mixer to the first chamber volume of the mixing chamber of the first mixer lies in the range of 15:1 to 1:1,
the ratio of said first volume ratio to said second volume ratio lies in the range of 50:1 to 1:10, preferably in the range of 20:1 to 1:1.

17. The device of claim 16, wherein the ratio of said first volume ratio to said second volume ratio lies in the range of 5:1 to 1:10.

18. The device of claim 17, further comprising
at least one first rotor blade (3a, 3b) of the first mixing rotors and the second mixing rotors has a first aspect ratio formed from the height of one of the first rotor blades (3a, 3b) to the effective diameter of said one first rotor blade (3a, 3b) in the range of 50:1 to 1:10; and
at least one second rotor blade (3a, 3b) of the first mixing rotors and the second mixing rotors has a second aspect ratio, wherein the second aspect ratio formed from the height of one of the second rotor blades (3a, 3b) to the effective diameter of said one second rotor blade (3a, 3b) lies in the range of 50:1 to 1:10.

19. The device of claim 18, wherein the ratio of the first aspect ratio to the second aspect ratio lies in the range of 100:1 to 1:10.

20. The device of claim 16, wherein a ratio of the minimum distance between the rotor blade tip (4) of a first rotor blade (3a, 3b) and an inner wall of the chamber housing of the first mixer to the minimum distance between the rotor blade tip (4) of a second rotor blade (3a, 3b) and the inner wall of the chamber housing of the second mixer lies in the range of 10:1 to 1:50.

21. The device of claim 16, wherein the first and second mixers each have two mixing rotors (1), wherein the ratio of the minimum distance between the rotor blade tip (4) of a first rotor blade (3a, 3b) of a mixing rotor (1) of the first mixer and the outer wall (10) of the mixing rotor core (2) of the other mixing rotor (1) of the first mixer to the minimum distance between the rotor blade tip (4) of a second rotor blade (3a, 3b) of a mixing rotor (1) of the second mixer and the outer wall (10) of the mixing rotor core (2) of the other mixing rotor (1) of the second mixer lies in the range of 50:1 to 1.01:1.

22. The device of claim 16, wherein
the volume ratio of the second chamber volume of the mixing chamber of the second mixer to the first chamber volume of the mixing chamber of the first mixer lies in the range of 14:1 to 1.1:1, and
the device produces non-vulcanized vehicle tire components.

23. The device of claim 16 configured to produce a rubber mixture or for producing non-vulcanized vehicle tire components and/or a vehicle tire.

24. The device of claim 16, the first mixer and the second mixer configured to:
A) mix of a rubber mixture in a first mixer, wherein the first mixer has a mixing chamber and at least one mixing rotor in the mixing chamber of the first mixer, wherein
ii. the mixing chamber of the first mixer has a first chamber volume,
iii. the mixing chamber of the first mixer is delimited by a chamber housing, a first filling opening and a first ejection opening, and
iv. the at least one mixing rotor (1) of the first mixer has a mixing rotor core (2) and at least two first rotor blades (3a, 3b),
B) trans of the rubber mixture mixed in the first mixer into a second mixer, wherein the second mixer has a mixing chamber and at least one mixing rotor (1) in the mixing chamber of the second mixer, wherein
v. the mixing chamber of the second mixer is delimited by a chamber housing, a second filling opening and a second ejection opening,
vi. the mixing chamber of the second mixer has a second chamber volume, wherein the volume ratio of the chamber volume of the mixing chamber of the second mixer to the chamber volume of the mixing chamber of the first mixer lies in the range of 15:1 to 1:1, and
vii. the at least one mixing rotor (1) of the second mixer has a mixing rotor core (2) and at least two second rotor blades (3a, 3b),
C) mix of the rubber mixture mixed in the first mixer in the second mixer, wherein the blade field speeds acting on the rubber mixture during usage step C) in the mixing chamber of the second mixer are lower than the blade field speeds acting on the rubber mixture during usage step A) in the mixing chamber of the first mixer.

25. The device of claim 16, wherein
the ratio of the blade field speeds acting on the rubber mixture during usage step A) in the mixing chamber of the first mixer to the blade field speeds acting on the rubber mixture during usage step C) in the mixing chamber of the second mixer lies in the range of 1 000 000:1 to 1.01:1; and
the blade field speeds acting on the rubber mixture during usage step A) in the mixing chamber of the first mixer lie in the range of 10 m/s to 300 m/s; and
the blade field speeds acting on the rubber mixture during usage step C) in the mixing chamber of the second mixer lie in the range of 1 m/s to 80 m/s.

26. The device of claim 16, wherein the second mixer has a supply unit for supplying rubber mixture constituents to the bottom chamber housing, preferably a supply unit for supplying vulcanization agents to the mixing chamber of the second mixer, wherein between usage steps A) to C), or during usage steps A) and/or C), vulcanization agents are transferred to the mixing chamber of the second mixer so that a non-vulcanized finished rubber mixture is produced during usage step C).

27. A method for producing non-vulcanized vehicle tire components comprising:
providing rubber mixture constituents,
mixing the rubber mixture constituents into a basic rubber mixture using a first mixer;
mixing of the basic rubber mixture with vulcanization agents and further rubber mixture constituents to produce a finished rubber mixture in a second mixer;
shaping and cutting the finished rubber mixture to produce non-vulcanized vehicle tire components; and
vulcanizing one or more of the vehicle tire components together with further tire components to produce a vehicle tire;
wherein the blade field speeds acting on the rubber mixture in the mixing chamber of the second mixer are lower than the blade field speeds acting on the rubber mixture in the mixing chamber of the first mixer.

28. The method of claim 27, wherein the rubber mixture comprises silica, wherein the silica proportion of the rubber mixture lies in the range of 1 phr to 200 phr and/or less than 0.1 phr soot is present in the rubber mixture, the silica proportion lies in the range of 40 phr to 190 phr.

29. The method of claim 27, wherein the rubber mixture comprises one or more silanes, wherein the silane proportion of the rubber mixture lies in the range of 0.01 phr to 50 phr.

30. The method of claim 27, wherein the rubber mixture comprises at least one rubber selected from the group consisting of IIR, EPDM, NR, IR, SBR, SSBR and BR.
